(19) United States
(12) Patent Application Publication
(10) Pub. No.: US 2008/0066997 A1
(43) Pub. Date: Mar. 20, 2008

(54) Soundproof structure

(75) Inventors: Hiroshi Wako, Saitama (JP); Junsei Hibiya, Saitama (JP)

Correspondence Address: BIRCH STEWART KOLASCH & BIRCH, PO BOX 747, FALLS CHURCH, VA, 22040-0747, US

(73) Assignee: HONDA MOTOR CO., LTD.

(21) Appl. No.: 11/896,246

(22) Filed: Aug. 30, 2007

(30) Foreign Application Priority Data
Sep. 14, 2006 (JP) 2006-250104

(51) Int. Cl. G10K 11/00

(52) U.S. Cl. 181/175

(57) ABSTRACT

A compact, low cost soundproof structure having a small number of parts utilizing ribs protruding from an inner face of a case of a power source or a power transmission device. In the soundproof structure, the ribs protruding from the inner face of the case form a single or a plurality of tubular bodies. A lid member covers an opening facing an inside of the case of the single or plurality of tubular bodies formed by the ribs to form a single or a plurality of tubular body inside spaces. Also, the single or plurality of tubular body inside spaces and an internal space of the case communicate with each other through a hole or holes bored in the lid member.

### CROSS-REFERENCE TO RELATED APPLICATION

The present application claims priority under 35 U.S.C. §119 to Japanese Patent Application No. 2006-250104, filed Sep. 14, 2006, the entire contents of which are hereby incorporated by reference.

### BACKGROUND OF THE INVENTION

1. Field of the Invention

The present invention relates to soundproof structure of a power source or a power transmission device.

2. Description of Background Art

As this type of soundproof structure, cover structure for covering a prime mover part of a working machine is disclosed in JP-A No. 2002-317463

The cover structure disclosed in an embodiment of JP-A No. 2002-317463 is a cover with double structure in which a hollow part is formed between an inner wall and an outer wall. Also, the cover structure is provided with a resonator for damping operating noise by resonance, with a hole provided in the inner wall.

Since the soundproof structure is provided on the cover covering the prime mover part rather than on a case forming the prime mover part, even when the prime mover part requires no cover, it is necessary to provide a special cover for soundproofing. Therefore, the cover occupies much space, thereby upsizing the prime mover part and increasing the number of parts and the cost.

When the cover itself has the double structure and the volume of the hollow part is ensured in order to obtain the effect as the resonator, the cover is increased in thickness, thereby further upsizing the prime mover part.

Accordingly, the present invention has been made in view of the foregoing, and an object of the present invention is to provide soundproof structure that has a small number of parts and is compact and low-cost by utilizing ribs provided to be protruded on an inner face of a case of a power source or a power transmission device.

### SUMMARY AND OBJECTS OF THE INVENTION

In order to accomplish the above-mentioned object, an embodiment of the present invention provides soundproof structure in which ribs protruded on an inner face of a case of a power source or a power transmission device are protruded to form a single or a plurality of tubular bodies. A lid member covers an opening facing an inside of the case of the single or plurality of tubular bodies formed by the ribs to form a single or a plurality of tubular body inside spaces. The single or plurality of tubular body inside spaces and an internal space of the case communicate with each other through a hole or holes bored in the lid member.

According to an embodiment of the present invention, the case serves as a transmission case for housing a belt continuously variable transmission for transmitting power of an internal combustion engine.

According to an embodiment of the present invention, the ribs are linearly formed on the inner face of the case, and the single or plurality of tubular bodies in a square tube shape are formed by the plurality of parallel ribs and the plurality of parallel ribs intersecting therewith.

Effects of the Invention include the following:

According to the soundproof structure of the present invention, a lid member covers an opening of a tubular body formed by ribs protruded on an inner face of a case of a power source or a power transmission device to form a tubular body inside space, and the tubular body inside space and an internal space of the case communicate with each other through a hole bored in the lid member. Thus, a soundproof effect can be obtained by composing a resonator for damping operating noise by resonance.

Since the resonator is composed, without a special cover for sound proofing, by utilizing the ribs protruded on the inner face of the case, it is possible to provide the soundproof structure that is compact, reduced in the number of parts, and low-cost.

According to the soundproof structure of the present invention, this structure is applied to a transmission case for housing a belt continuously variable transmission for transmitting power of an internal combustion engine, thereby composing the resonator utilizing the ribs protruded on the inner face of the transmission case. Therefore, since it is unnecessary to compose the resonator while protruding the resonator to the outside of the case, upsizing of the case can be avoided, and a high soundproof effect can be obtained.

According to the soundproof structure of the present invention, the ribs are linearly formed on the inner face of the case, and the single or plurality of tubular bodies in a square tube shape are formed by the plurality of parallel ribs and the plurality of parallel ribs intersecting therewith. Thus, it is possible to increase the reinforcing function of the case, and to easily form a large number of tubular bodies in the square tube shape. Also, the high soundproof effect can be expected.

Further scope of applicability of the present invention will become apparent from the detailed description given hereinafter. However, it should be understood that the detailed description and specific examples, while indicating preferred embodiments of the invention, are given by way of illustration only, since various changes and modifications within the spirit and scope of the invention will become apparent to those skilled in the art from this detailed description.

### BRIEF DESCRIPTION OF THE DRAWINGS

The present invention will become more fully understood from the detailed description given hereinbelow and the accompanying drawings which are given by way of illustration only, and thus are not limitative of the present invention, and wherein:

FIG. 1 is a general side view of a motorcycle mounted with a power unit incorporating the soundproof structure according to an embodiment of the present invention;

FIG. 2 is a side view, with portions removed, of the power unit;

FIG. 3 is a left side view of a transmission case; and

FIG. 4 is a sectional view of the transmission case (a sectional view taken along the line IV-IV of FIG. 3).

### DETAILED DESCRIPTION OF THE PREFERRED EMBODIMENTS

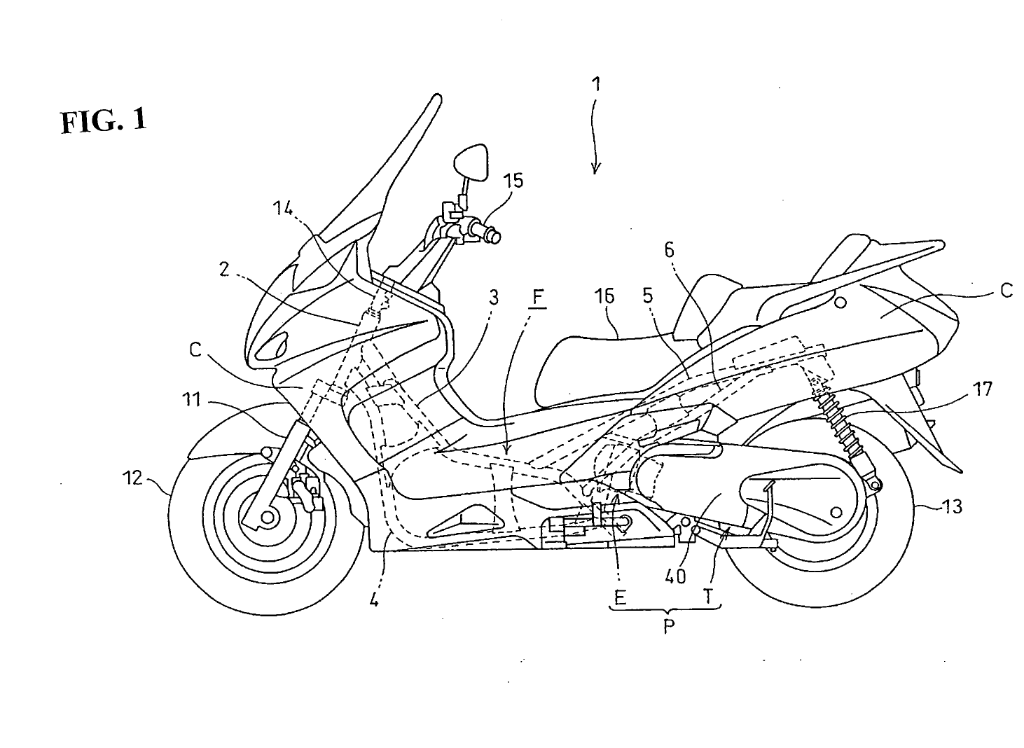

The soundproof structure according to this embodiment is applied to a transmission case of a power unit P mounted on a motorcycle 1. FIG. 1 is a general side view of the motorcycle 1.

A body frame F is covered with a body cover C to compose a vehicle body. The power unit P supported by the body frame F is composed of a water-cooled, single-cylinder, four-stroke internal combustion engine E, and a belt continuously variable transmission T provided to extend rearwardly with deviation to the left side from the internal combustion engine E. A crankshaft 25 of the internal combustion engine E is mounted on the body frame F in a transverse-mounted attitude in which the crankshaft 25 is directed to the vehicle width direction.

In this embodiment, the terms “up and down”, “front and rear”, and “left and right” refer to the directions viewed on the basis of the motorcycle 1.

The body frame F is provided with a head pipe 2 on a front end portion, a pair of left and right main frames 3 tilted downwardly from the head pipe 2 to extend rearwardly, a pair of left and right down tubes 4 extending substantially vertically downward from the head pipe 2, bent to extend substantially horizontally rearward, and connected to rear portions of the main frames 3, a pair of left and right seat rails 5 connected to portions slightly closer to the rear than the center of the main frames 3 and tilted upwardly to extend rearward, and a pair of left and right rear frames 6 for connecting rear portions of the main frames 3 to rear portions of the seat rails 5.

A front wheel 12 is journaled to lower ends of front forks 11 turnably supported by the head pipe 2, and a rear wheel 13 is journaled to a reduction gear mechanism provided on a rear portion of the belt continuously variable transmission T provided to extend in the rear of the power unit P.

On an upper end of a steering shaft 14 integrated with the front fork 11, a handlebar 15 is provided in a laterally spread manner.

In the power unit P, the internal combustion engine E on a front portion thereof is swingably supported by the body frame F at the vehicle body center portion, and a rear cushion 17 is interposed between a rear end portion of the belt continuously variable transmission T and seat rails 5 for supporting a tandem seat 16.

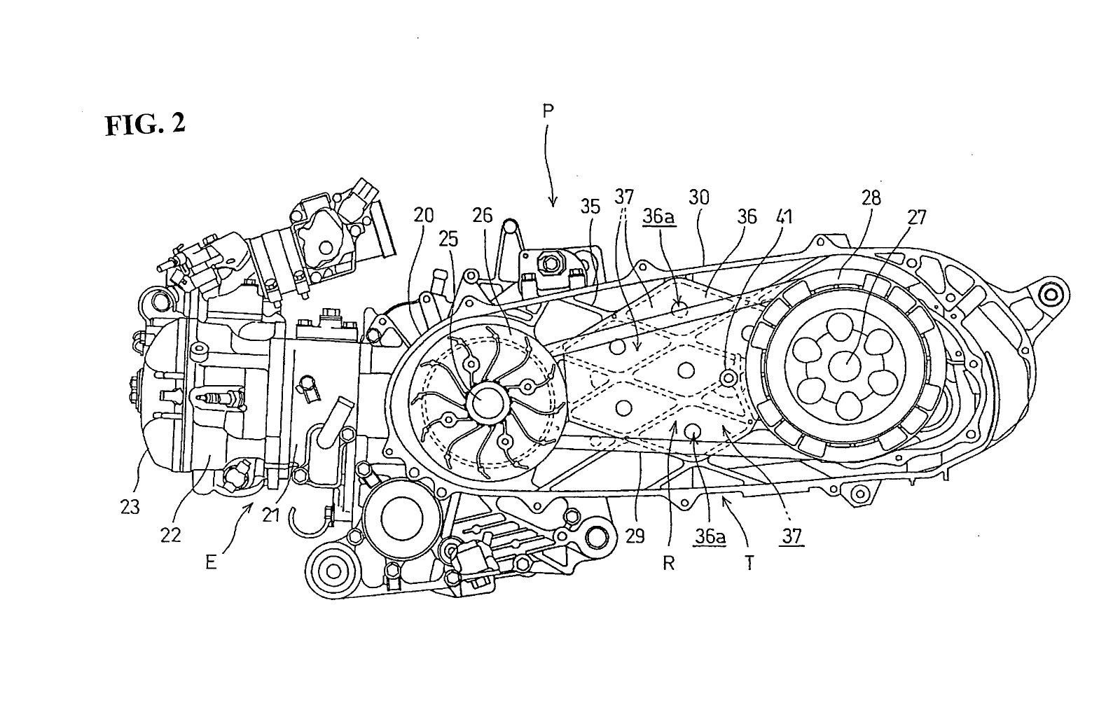

Referring to FIG. 2 that is a general side view, with portions omitted, of the power unit P, a front portion of a unit case of the power unit P composes a crankcase 20 of the internal combustion engine E. Also, a cylinder block 21, a cylinder head 22, and a cylinder head cover 23 are arranged in a sequentially overlapped manner while protruding forwardly from the crankcase 20, and are mutually integrally connected.

The unit case is divided into left and right portions. The left unit case forming a portion of the crankcase 20 extends rearwardly to compose a transmission case 30 for housing the belt continuously variable transmission T.

The transmission case 30 is longitudinally long, opened to the left, and covered with a transmission case cover 40 from the left side. Also, a power transmission chamber 41 for housing the belt continuously variable transmission T is formed inside the transmission case 30.

FIG. 2 is a side view of the power unit P, with the transmission case cover 40 removed.

In front of the power transmission chamber 41, a driving pulley 26 is provided on a left end of the crankshaft 25 journaled to the crankcase 20 of the internal combustion engine E so as to be directed to the lateral direction. A driven shaft 27 is journaled to the rear of the power transmission chamber 41, and a driven pulley 28 is provided on the driven shaft 27.

A V-belt 29 is extended between the driving pulley 26 in front and the driven pulley 28 in the rear to compose the belt continuously variable transmission T.

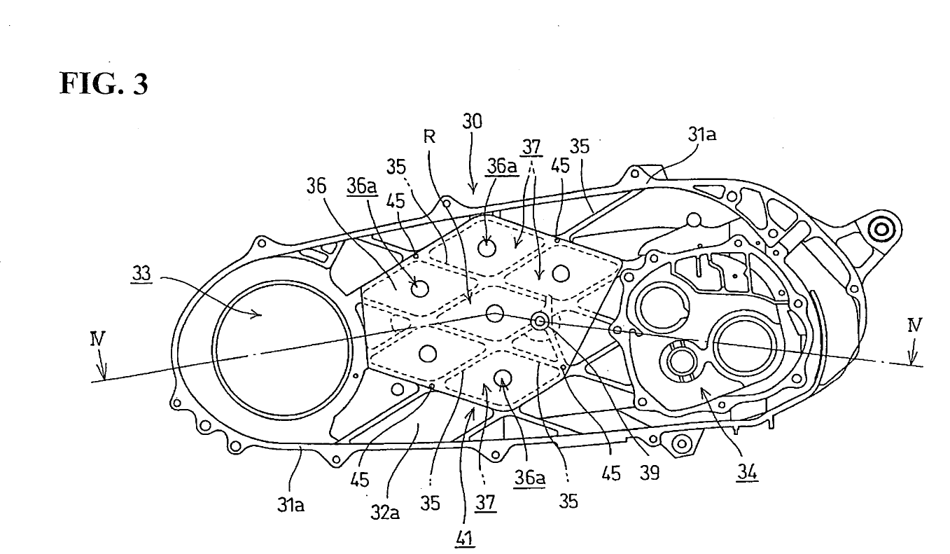

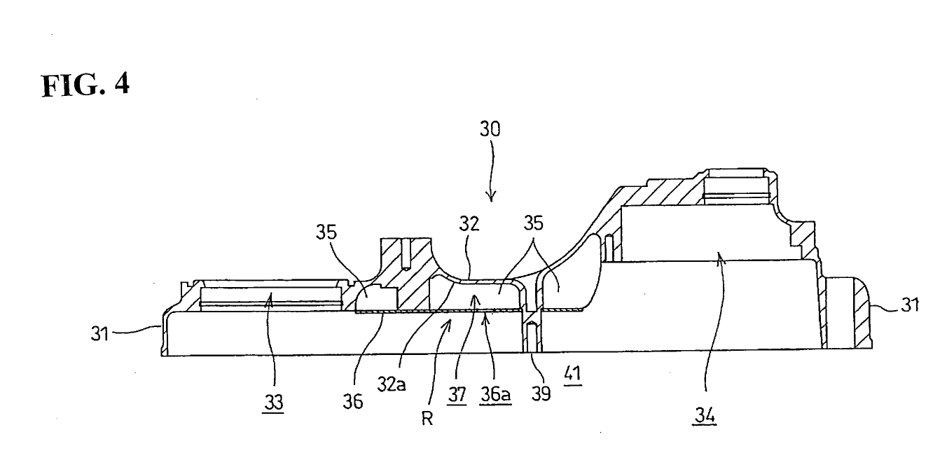

In the transmission case 30, the periphery of the belt continuously variable transmission T is surrounded with an outer peripheral wall 31, and a left end surface of the outer peripheral wall 31 serves as a mating surface 31a with the transmission case cover 40. FIG. 3 is a left side view of the transmission case 30, and shows the power transmission chamber 41. FIG. 4 shows a sectional view of the transmission case 30.

Referring to FIGS. 3 and 4, a vertical side wall 32 surrounded with the outer peripheral wall 31 of the transmission case 30 has a circular bearing hole 33 allowing the crankshaft 25 to pass through in front thereof, and a recess 34 for housing the reduction gear mechanism in the rear thereof. A plurality of ribs 35 protrude on an inner face 32a between the circular bearing hole 33 and the recess 34 to maintain rigidity and strength of the transmission case 30.

The ribs 35 formed to be protruded on the inner face 32a of the side wall 32 of the transmission case 30 are linearly formed, and a plurality of tubular bodies in the square (rhomboidal) tube shape are formed by the plurality of parallel ribs 35 and the plurality of parallel ribs 35 intersecting therewith.

The end faces of the ribs are almost flush with one another. A partially tabular lid member 36 abuts on the end faces of the ribs 35, and simultaneously covers openings of the plurality of tubular bodies to form a tubular body inside space 37 for each tubular body. Screws 45 at four peripheral edge portions thereof fixedly secure the lid member 36, to be mounted.

Also, on the inner face 32a of the transmission case 30, a mounting boss portion 39 used in mounting the transmission case cover 40 partially protrudes to the left. A through hole through which the mounting boss portion 39 passes through is formed in the lid member 36. When the lid member 36 is mounted on the ribs 35, the mounting boss portion 39 passes through the through hole to protrude to the left.

Furthermore, a circular hole 36a corresponding to each of the tubular body inside spaces 37 is bored in the lid member 36. The power transmission chamber 41 inside the transmission case 30 and the tubular body inside spaces 37 communicate with each other through the circular holes 36a.

More specifically, on the inner face 32a of the transmission case 30 for housing the belt continuously variable transmission T, the tubular body inside spaces 37 formed by dividing the space into a plurality of parts by utilizing the ribs 35 are provided so as to communicate with the power transmission chamber 41 through the circular holes 36a, and compose a resonator R.

Thus, the resonator R formed on the inner face 32a of the transmission case 30 can damp the operating noise of the internal combustion engine E, the belt continuously variable transmission T, or the like by resonance.

By properly setting the volume or number of the tubular body inside spaces 37, or the circular holes 36a, it is possible to effectively damp sound of a specific frequency, such as engine sound or transmission sound, by resonance.

The transmission case 30 not only serves to house the belt continuously variable transmission T but also serves as a case composing the belt continuously variable transmission T, and incorporates the soundproof structure in which the resonator R is formed on the transmission case 30. The soundproof structure is not the structure in which a cover is additionally provided and the resonator is formed on the cover. Therefore, the power unit P is not increased in size.

Since the resonator R is formed by utilizing the ribs 35 formed to be protruded on the inner face 32a of the transmission case 30, it is possible to provide the soundproof structure with a small number of parts at low cost.

The resonator R is formed on the inner face of the transmission case 30 by utilizing the ribs 35. Therefore, it is unnecessary to form the resonator while protruding the resonator to the outside of the case, thereby avoiding an increase in size of the transmission case 30, and a high soundproof effect can be obtained by deadening the sound with the resonator R provided at the inner face of the transmission case 30 that is closer to a sound source.

The plurality of ribs 35 are linearly formed on the inner face 32a of the transmission case 30, and the plurality of tubular bodies in the square (rhomboidal) tube shape are formed by the plurality of parallel ribs 35 and the plurality of parallel ribs 35 intersecting therewith. Thus, it is possible to increase the reinforcing function of the case, and to easily form a large number of tubular bodies inside spaces 37 by using the plurality of tubular bodies. The high soundproof effect can be expected by the most effective setting.

By changing the shape of the lid member 36, the number of the tubular body inside spaces 37 formed by closing the openings of the tubular bodies can be easily changed. In addition, the sizes of the circular holes 36a formed in the lid member 36 can be easily changed, thereby easily applying the lid member 36 to the power units P different in model.

The lid member formed according to the shapes of the openings of the tubular bodies, with a hole bored in the center thereof, may be fitted in the openings of the respective tubular bodies to form a plurality of tubular body inside spaces. Also, there are various methods for mounting the lid member.

The invention being thus described, it will be obvious that the same may be varied in many ways. Such variations are not to be regarded as a departure from the spirit and scope of the invention, and all such modifications as would be obvious to one skilled in the art are intended to be included within the scope of the following claims.

What is claimed is:

1. A soundproof structure, comprising:
a rib protruding on an inner face of a case of a power source or a power transmission device, the rib forming a single or a plurality of tubular bodies;
a lid member covering an opening facing an inside of the case and the single or plurality of tubular bodies formed by the rib so as to form a single or a plurality of tubular body inside spaces,
wherein the single or plurality of tubular body inside spaces and an internal space of the case communicate with each other through a hole bored in the lid member.

2. The soundproof structure according to claim 1,
wherein the case is a transmission case housing a belt continuously variable transmission for transmitting power of an internal combustion engine.

3. The soundproof structure according to claim 1,
wherein the rib comprises multiple ribs,
the multiple ribs including a first group of at least two linear ribs formed on an inner face of the case and extending parallel to each other in a first direction, and a second group of at least two linear ribs formed on an inner face of the case and extending parallel to each other in a second direction,
wherein the single or plurality of four-sided tubular bodies are formed by intersections of the first group of parallel ribs extending in the first direction and the second group of parallel ribs extending in the second direction.

4. The soundproof structure according to claim 2,
wherein the rib comprises multiple ribs,
the multiple ribs including a first group of at least two linear ribs formed on an inner face of the case and extending parallel to each other in a first direction, and a second group of at least two linear ribs formed on an inner face of the case and extending parallel to each other in a second direction,
wherein the single or plurality of four-sided tubular bodies are formed by intersections of the first group of parallel ribs extending in the first direction and the second group of parallel ribs extending in the second direction.

5. The soundproof structure according to claim 1 is a resonator.

6. The soundproof structure according to claim 1, wherein the tubular bodies have a rhomboidal-shape.

7. The soundproof structure according to claim 3, wherein the first group of parallel ribs and the second group of parallel ribs each include four parallel ribs.

8. The soundproof structure according to claim 1, wherein the rib is a linear rib arranged at an angle to a length of the case.

9. The soundproof structure according to claim 1, wherein the lid has six peripheral edge portions.

10. The soundproof structure according to claim 1, wherein the lid member abuts on an end face of the rib, and simultaneously covers the opening of the single of the plurality of tubular bodies.

11. A soundproof structure, comprising:
at least four ribs protruding on an inner face of a case of a power source or a power transmission device, the ribs forming a single or a plurality of tubular bodies;
a lid member covering an opening facing an inside of the case and the single or plurality of tubular bodies formed by the ribs so as to form a single or a plurality of tubular body inside spaces,
wherein the single or plurality of tubular body inside spaces and an internal space of the case communicate with each other through a hole bored in the lid member.

12. The soundproof structure according to claim 11,
wherein the case is a transmission case housing a belt continuously variable transmission for transmitting power of an internal combustion engine.

13. The soundproof structure according to claim 11,
wherein the at least four ribs include a first group of at least two linear ribs formed on an inner face of the case and extending parallel to each other in a first direction, and a second group of at least two linear ribs formed on an inner face of the case and extending parallel to each other in a second direction,
wherein the single or plurality of four-sided tubular bodies are formed by intersections of the first group of parallel ribs extending in the first direction and the second group of parallel ribs extending in the second direction.

14. The soundproof structure according to claim 12,
wherein the at least four ribs include a first group of at least two linear ribs formed on an inner face of the case and extending parallel to each other in a first direction, and a second group of at least two linear ribs formed on an inner face of the case and extending parallel to each other in a second direction,
wherein the single or plurality of four-sided tubular bodies are formed by intersections of the first group of parallel ribs extending in the first direction and the second group of parallel ribs extending in the second direction.

15. The soundproof structure according to claim 11 is a resonator.

16. The soundproof structure according to claim 11, wherein the tubular bodies have a rhomboidal-shape.

17. The soundproof structure according to claim 13, wherein the first group of parallel ribs and the second group of parallel ribs each include four parallel ribs.

18. The soundproof structure according to claim 11, wherein the ribs are linear ribs arranged at an angle to a length of the case.

19. The soundproof structure according to claim 11, wherein the lid member abuts on end faces of the ribs, and simultaneously covers the opening of the single of the plurality of tubular bodies.

20. A soundproof structure, comprising:
multiple ribs protruding on an inner face of a case of a power source or a power transmission device, the rib forming a single or a plurality of tubular bodies;
a lid member covering an opening facing an inside of the case and the single or plurality of tubular bodies formed by the ribs so as to form a single or a plurality of tubular body inside spaces,
wherein the single or plurality of tubular body inside spaces and an internal space of the case communicate with each other through a hole bored in the lid member,
wherein the lid has a plurality of peripheral edge portions, four of which are secured to an inside of the case by screws.
